(19) United States
(12) Patent Application Publication
(10) Pub. No.: US 2018/0358920 A1
(43) Pub. Date: Dec. 13, 2018

(54) BUILDING INTEGRATED PHOTOVOLTAIC SYSTEMS

(71) Applicant: CHE Power Structures Corporation, Vancouver (CA)

(72) Inventors: Alberto CAYUELA, North Vancouver (CA); Robert Andrew LORDON, Calgary (CA); Alexander Ross Craig SMITH, Vancouver (CA)

(21) Appl. No.: 16/005,253

(22) Filed: Jun. 11, 2018

Related U.S. Application Data
(60) Provisional application No. 62/519,107, filed on Jun. 13, 2017.

(51) Int. Cl. H02S 20/23; H02S 30/10; H02S 40/34

(52) U.S. Cl. CPC H02S 20/23; H01R 13/625; H02S 40/34; H02S 30/10

(57) ABSTRACT

A bonding assembly for joining a rooftop assembly and a photovoltaic (PV) assembly is provided. The bonding assembly includes: an elongate channel component an elongate cover component engageable with the channel component to form a generally P-shape cross section; wherein the channel component includes a first divider perpendicular and integrally formed with a second divider, wherein the cover component includes a side portion perpendicular and integrally formed with a top portion, wherein the top portion is perpendicular and integrally formed with an inner portion; wherein an upper segment of the side portion, the top portion, the inner portion, the first divider and the second divider define a first channel; wherein the second divider includes a first flange portion extending diagonally upwardly and inwardly into the first channel; wherein a gap is provided between an end portion of the inner portion and the first flange portion; wherein the second divider includes a second flange portion extending horizontally and inwardly in direction opposite to the first channel.

### TECHNICAL FIELD

This invention relates to the field of Building Integrated Photovoltaics (BIPV) systems that generate electricity and act as an integral building component, such as a roof.

### BACKGROUND

Solar energy has received increasing attention as an alternative energy source. Solar energy is renewable and does not contribute to greenhouse effects caused by the combustion of non-renewable energy sources, such as coal and oil.

Photovoltaic (PV) panels are used to capture and convert solar energy into electricity. PV panels have many advantages other than not contributing to environmental pollution. For example, PV panels can help stabilize the power grid and lower utility bills.

Finished buildings may be retrofitted with PV panels. For example, PV panels may be installed on finished flat or pitched roofs. The assembly and installation of such PV panels may be difficult and may require structural alterations or upgrades to the building.

BIPV assemblies combine building materials with PV panels to form building products that can be directly integrated into a building during its construction. BIPV assemblies have successfully replaced certain types of building products since the late 1990s. For example, solar shading devices fitted with PV cells are known. Other exemplary BIPV assemblies include windows and building facades. Design and installation of BIPV assemblies can be time-consuming, complicated and require special expertise for example in architectural design, structural engineering and electrical wiring.

BIPV assemblies that are simple and easy to install are desirable.

### SUMMARY

The following embodiments and aspects thereof are described and illustrated in conjunction with apparatus, methods and systems which are meant to be exemplary and illustrative, not limiting in scope. In various embodiments, one or more of the above-described problems have been reduced or eliminated, while other embodiments are directed to other improvements.

One aspect provides a bonding assembly for joining a rooftop assembly and a photovoltaic (PV) assembly. The bonding assembly comprises: an elongate channel component an elongate cover component engageable with the channel component to form a generally P-shape cross section; wherein the channel component comprises a first divider perpendicular and integrally formed with a second divider, wherein the cover component comprises a side portion perpendicular and integrally formed with a top portion, wherein the top portion is perpendicular and integrally formed with an inner portion; wherein an upper segment of the side portion, the top portion, the inner portion, the first divider and the second divider define a first channel; wherein the second divider comprises a first flange portion extending diagonally upwardly and inwardly into the first channel; wherein a gap is provided between an end portion of the inner portion and the first flange portion; wherein the second divider comprises a second flange portion extending horizontally and inwardly in direction opposite to the first channel.

The second flange may culminate in an end portion extending diagonally and inwardly. The channel component and cover component may comprise corresponding engaging means. The engaging means may be provided at an end of the first divider—of the channel component and a mid-region of the side portion of he cover component. The engaging means may comprise spaced apart ridges on the cover component configured to fittingly receive the end of the first divider of the channel component. The first divider of the channel component and a lower segment of the side portion of the cover component may define a second region. The second divider of the channel component and the inner portion of the cover component may define a third region. A ratio of a height of a channel segment and the width of the channel segment may range from 0.8 to 1.2.

Another aspect provides a building integrated photovoltaic (BIPV) system. The system comprises a bonding assembly as described herein; cut-to-size electrical connectors (with twist locks) of a photovoltaic (PV) panel of a PV assembly received in the first channel of the bonding assembly; a roofing assembly received in the second region channel of the bonding assembly; and the PV assembly received in the third region of the bonding assembly.

The PV assembly may comprise the PV panel and a PV support frame. The PV support frame may comprise a drain channel, wherein the end portion of the second flange extends diagonally and inwardly toward the drain channel. The height of the channel segment may be approximately the same as a thickness of the PV assembly. The top portion of the cover component may be approximately flush with a top surface of the PV panel. The roofing assembly may comprise a batten, a sheathing member, and a framing member. The sheathing member may be lined with a waterproof membrane. Outer edges of the batten, the sheathing member, the framing member and the waterproof membrane may abut a lower segment of the side portion of the cover component.

Another aspect provides a residential garage. The garage comprises a BIPV assembly as described herein; and a garage assembly. The roof may be a mono-pitched roof or a flat roof.

Another aspect provides a method of making a residential garage. The method comprises:
(a) determining a pitch and/or orientation of a roof of the garage to optimize capture of solar radiation based on a site where the garage is to be located;
(b) constructing a pad and an apron on the site;
(c) constructing a residential garage according to claim 18 on the site.

Another aspect provides a kit for a residential garage. The kit comprises components of a residential garage as described herein, wherein the components are sized, cut to fit, and palletized; and an installation manual with instructions setting out a method of making a residential garage as described herein.

In addition to the exemplary aspects and embodiments described above, further aspects and embodiments will become apparent by reference to the drawings and by study of the following detailed descriptions.

### BRIEF DESCRIPTION OF THE DRAWINGS

Exemplary embodiments are illustrated in referenced figures of the drawings. It is intended that the embodiments and figures disclosed herein are to be considered illustrative rather than restrictive.

FIG. 1A shows a perspective view of a portion of a bonding assembly according to an embodiment of the invention.

FIG. 1B shows a cross-sectional view of the bonding assembly shown in FIG. 1.

FIG. 1C shows a close-up partial cross-sectional view of a BIPV assembly incorporating the bonding assembly shown in FIG. 1.

FIG. 1D shows a partial exposed perspective view of the BIPV assembly shown in FIG. 1C.

FIG. 2A shows a cross-sectional view of a bonding assembly according to an embodiment of the invention.

FIG. 2B shows a cross-sectional view of a bonding assembly according to an embodiment of the invention.

FIG. 2C shows a cross-sectional view of a bonding assembly according to an embodiment of the invention.

FIG. 2D shows a cross-sectional view of a bonding assembly according to an embodiment of the invention.

FIG. 2E shows a cross-sectional view of a bonding assembly according to an embodiment of the invention.

FIG. 2F shows a cross-sectional view of a BIPV assembly incorporating the bonding assembly shown in FIG. 2E.

FIG. 2G shows a partial exposed perspective view of the BIPV assembly shown in FIG. 2F.

FIG. 2H shows a partial exposed top view of the BIPV assembly shown in FIG. 2F.

FIG. 2I shows a cross-sectional view of a bonding assembly according to an embodiment of the invention.

FIG. 3 shows a wiring scheme of a BIPV assembly according to an embodiment of the invention.

FIG. 4A shows a cross-sectional view of a bonding assembly according to an embodiment of the invention.

FIG. 4B shows a close up partial cross-sectional view of a BIPV assembly incorporating the bonding assembly shown in FIG. 3A.

FIG. 4C shows a cross-sectional view of a bonding assembly according to an embodiment of the invention.

FIG. 5 shows a partial cross-sectional view of a portion of a flashing component according to an embodiment of the invention.

FIG. 6 shows a perspective view of a garage integrated with a BIPV assembly according to an embodiment of the invention.

FIG. 7 shows a floorplan of the garage shown in FIG. 6.

FIG. 8 shows a cross-section view of the garage shown in FIG. 6.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

The terms “inwardly”, “inner” and the like as used in this specification refer to a direction toward the building structure.

The terms “outwardly”, “outer” and the like as used in this specification refer to a direction away from the building structure.

The terms “upper”, “upwardly”, and the like as used in this specification refer to a direction away from the ground surface.

The terms “lower”, “downwardly”, and like terms as used in this specification refer to a direction toward a ground surface.

The inventors have developed a bonding assembly that securely joins building structural members and PV panels to provide a BIPV assembly. The BIPV assembly disclosed herein may be used to provide an easy-to-assemble, complete roof structure.

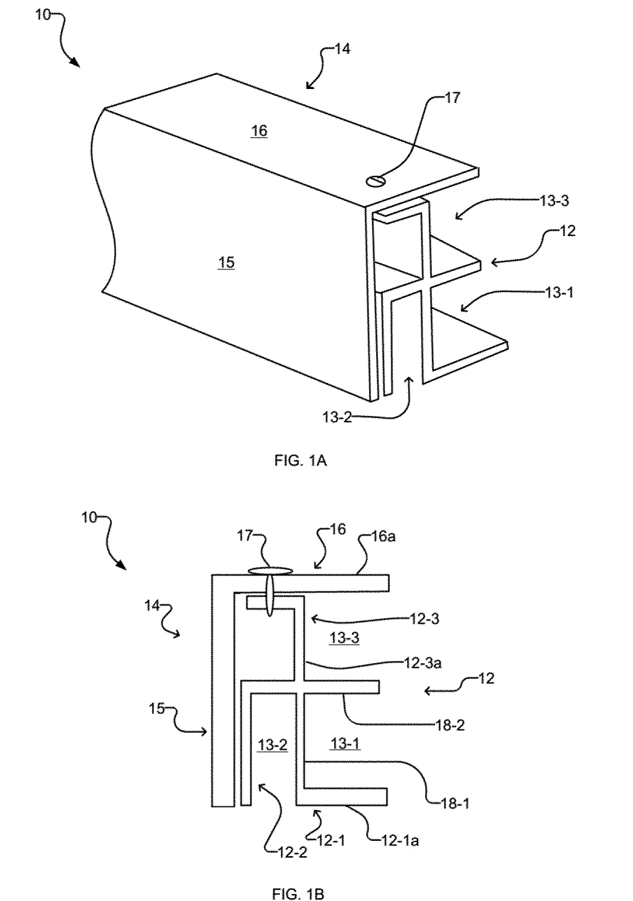

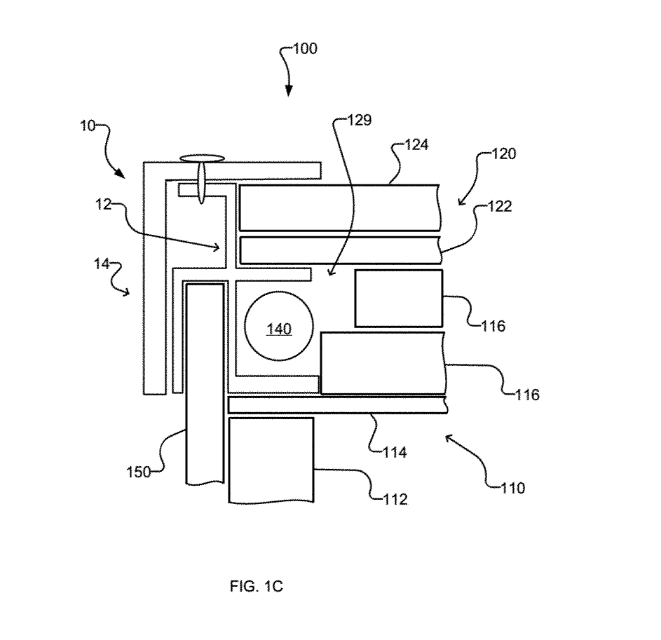

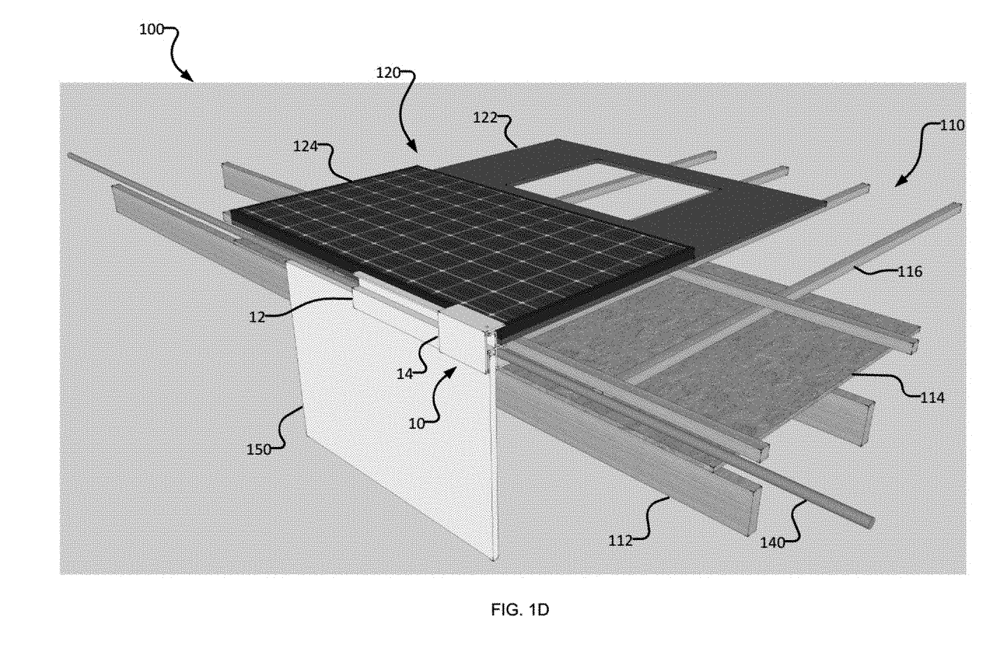

FIGS. 1A to 1D show a bonding assembly 10, and a BIPV assembly 100 incorporating bonding assembly 10, according to embodiments of the invention. BIPV assembly 100 is a rooftop and bonding assembly 10 forms a continuous, watertight, and windproof periphery of the rooftop.

Bonding assembly 10 may be made of any suitable building material, such as composite UV-resistant, fire-rated, dielectric hard plastic or aluminum. Bonding assembly 10 has an elongated body that forms the periphery of a building structure. In some embodiments, a plurality of bonding assemblies 10 are connected together to form the periphery of a building structure. In some embodiments, bonding assembly 10 is provided as a single frame that forms the periphery of a building structure. While the present description focuses on embodiments of the invention of particular commercial advantage, namely rooftops as a building structure, suitable modifications could be made by a person skilled in the art to provide embodiments of other building structures such as walls and the like.

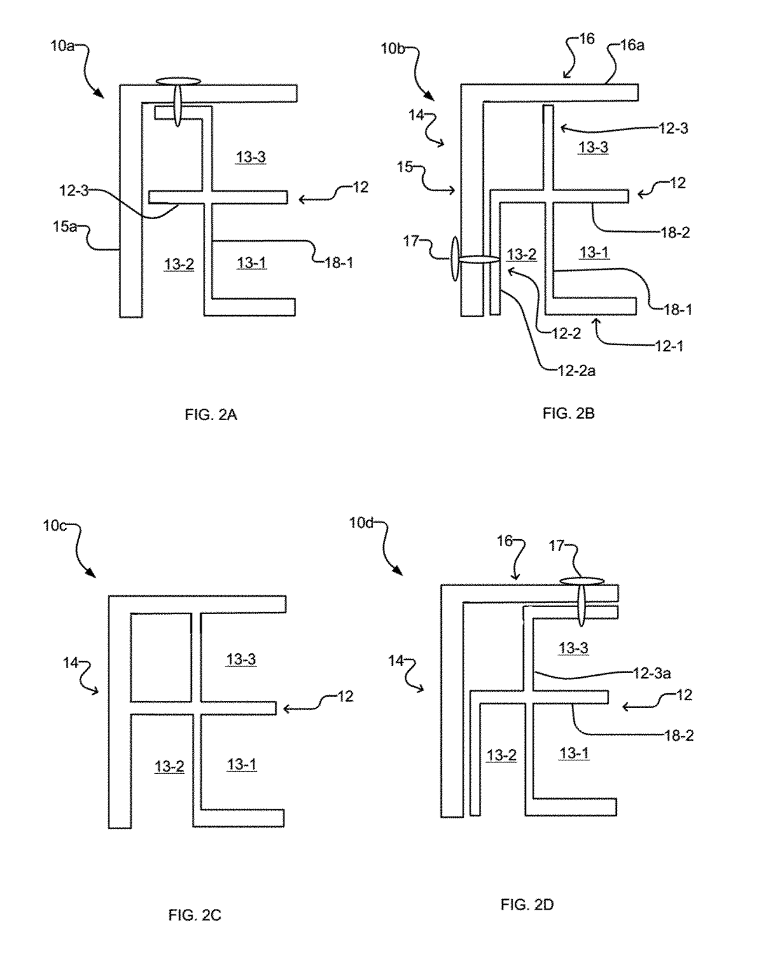

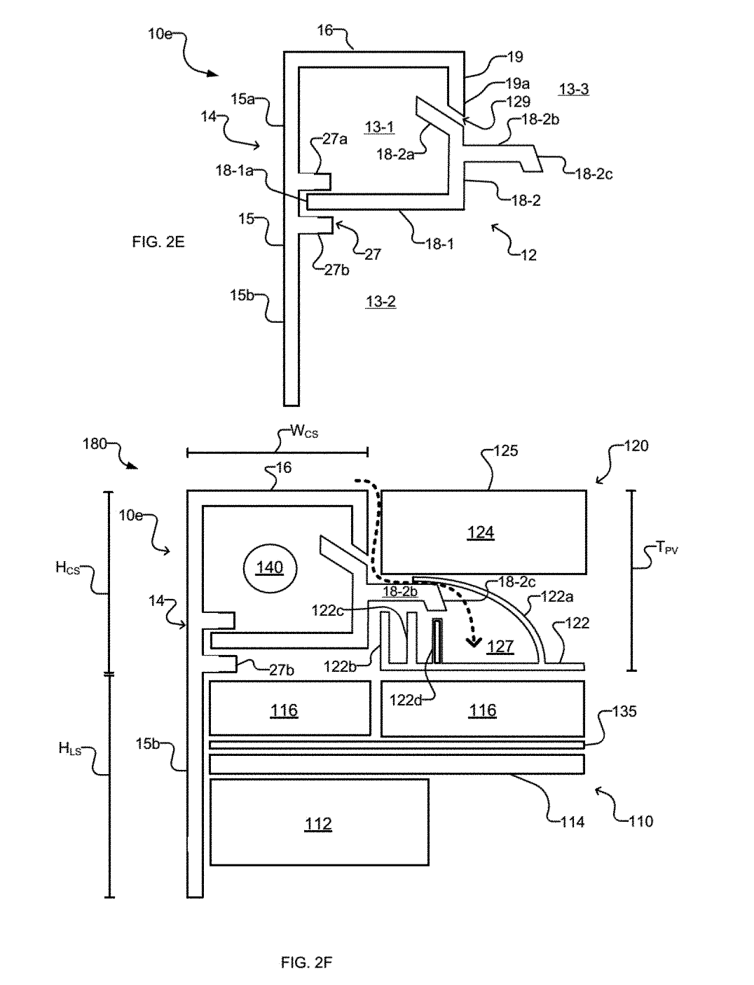

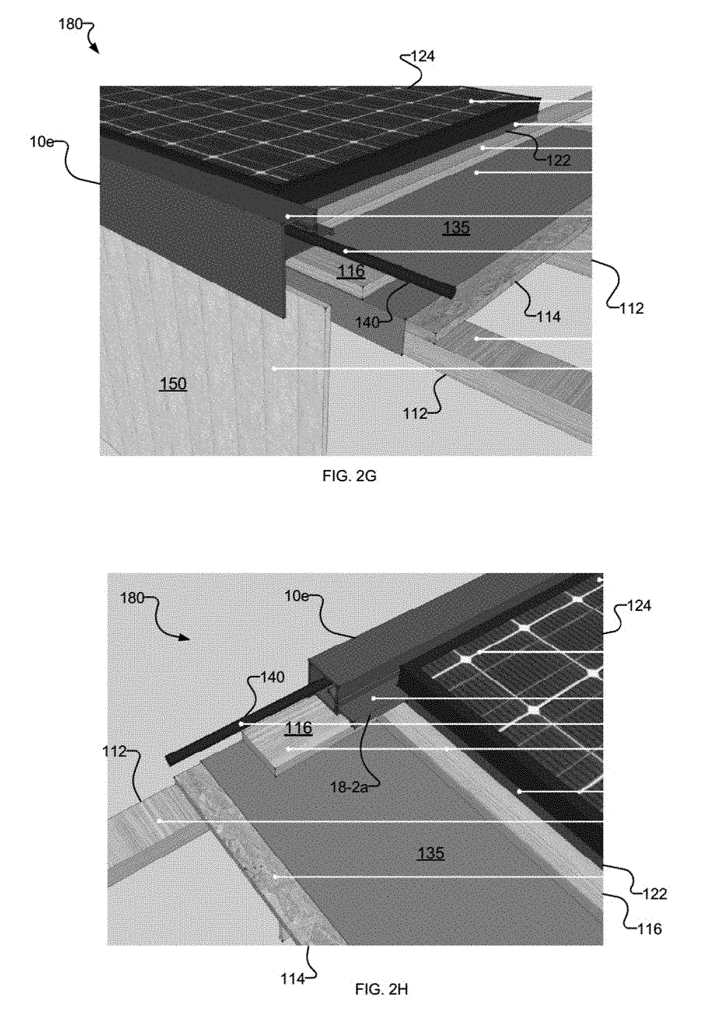

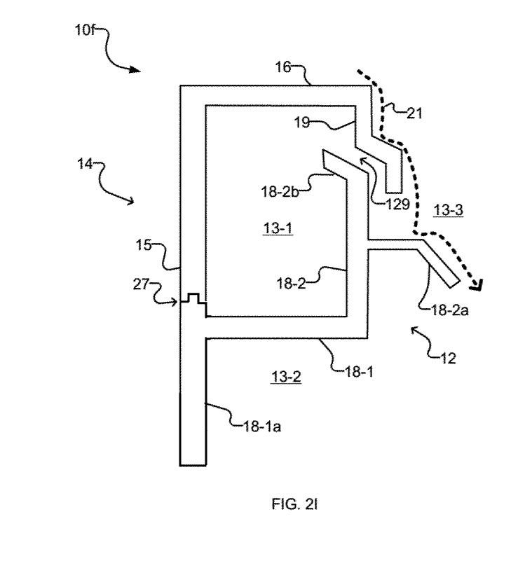

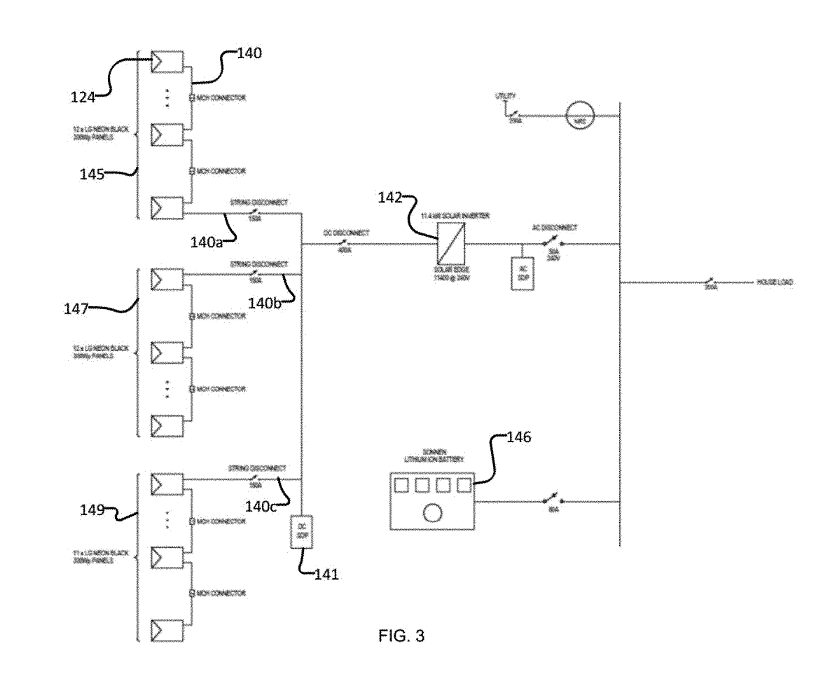

As best shown in FIGS. 1A and 1B, bonding assembly 10 has a channel component 12 and a cover component 14. In some embodiments, channel component 12 and cover component 14 are manufactured separately and subsequently coupled together by one or more fasteners 17. Fasteners 17 may be any suitable means known in the art such as a male/female clipping mechanism, screws, and the like. In some embodiments, cover component 14 is integrally formed with channel component 12, as in the bonding assembly 10c shown in FIG. 2C.

Channel component 12 has an elongated body with sufficient length to extend along the periphery of a building structure, or along one side of a periphery of a building structure, or along part of one side of a periphery of a building structure.

Channel component 12 at least partially defines a first channel 13-1, a second channel 13-2, and a third channel 13-3. First channel 13-1 is adjacent to second channel 13-2, the two channels are separated by a first divider 18-1 of channel component 12. First channel 13-1 is also adjacent to third channel 13-3, the two channels are separated by a second divider 18-2 of channel component 12. First divider 18-1 is oriented perpendicular to second divider 18-2.

Channel component 12 has a generally cross-shaped cross-section formed by L-shaped portion 12-1, linear second divider 18-2, L-shaped portion 12-2 and L-shaped portion 12-3. The proximal portion of L-shaped portion 12-1 consists of first divider 18-1. L-shaped portion 12-1 also has a distal portion 12-la perpendicular to first divider 18-1.

Cover component 14 has a generally L-shaped cross-section and couples to channel component 12. Cover component 14 has an elongated body and may extend to a length corresponding to the length of channel component 12. Cover component 14 comprises a top portion 16 and a perpendicularly extending side portion 15. In some embodiments, cover component 14 is coupled to channel component 12 by way of: one or more fasteners 17 fastening top portion 16 of cover component 14 to L-shaped portion 12-2 of channel component 12; and/or one or more fasteners 16 fastening side portion 15 of cover component 14 to L-shaped portion 12-3 of channel component 12.

L-shaped portion 12-1 and second divider 18-2 together form a U-shaped portion defining first channel 13-1. First divider 18-1 and L-shaped portion 12-2 together form a U-shaped portion defining second channel 13-2. A distal portion 16a of top portion 14, a proximal portion 12-3a of L-shaped portion 12-3, and second divider 18-2, together form a U-shaped portion defining third channel 13-3.

In some embodiments, one or more of L-shaped portions 12-1, 12-2 and 12-3 may be linear portions instead of L-shaped portions such that the distal portion perpendicular to the proximal portion is absent. For example, in the bonding assembly 10a as shown in FIG. 2A, the distal portion of L-shaped portion 12-2 is absent, such that the U-shaped second channel 13-2 is defined by first divider 18-1 and a linear portion 12-2 of channel component 12, and a distal portion 15a of side portion 15 of cover component 14. Or for example, in the bonding assembly 10b as shown in FIG. 2B, the distal portion of L-shaped portion 12-3 is absent, and cover component 14 is fastened by fastener 17 at side portion 15 of cover component 14 and a distal portion 12-2a of channel component 12.

In some embodiments, one or more of the distal portions of the L-shaped portions 12-1, 12-2 and 12-3 may be oriented in the opposite direction. For example, in the bonding assembly 10d as shown in FIG. 2D, the distal portion 12-3a of L-shaped portion 12-3 extends in the opposite direction from that of bonding assembly 10, such that U-shaped third channel 13-3 is defined by L-shaped portion 12-3 and second divider 18-2.

FIG. 2E shows a bonding assembly 10e according to another embodiment. Channel component 12 and a cover component 14 are engageable to form a generally P-shaped cross-section. Cover component 14 includes a side portion 15 which is perpendicular and integrally formed with a top portion 16 which is perpendicular and integrally formed with an inner portion 19. Channel component 12 includes a first divider 18-1 which is perpendicular and integrally formed with a second divider 18-2.

An upper segment 15a of side portion 15, top portion 16, inner portion 19, first divider 18-1 and second divider 18-2 together define first channel 13-1. Second divider 18-2 includes a first flange portion 18-2a extending diagonally upwardly and inwardly into first channel 13-1. A gap 129 is provided between end portion 19a of inner portion 19 and first flange portion 18-2a. Second divider 18-2 also includes a second flange portion 18-2b extending horizontally and inwardly (i.e., in an opposite direction from first channel 13-1), and culminating in an end portion 18-2c extending diagonally downwardly and inwardly.

Channel component 12 and cover component 14 have corresponding engaging means 27 for coupling the two components together. In the illustrated embodiment, end portion 27c of first divider 18 of channel component 12 is received between spaced apart ridges 27a and 27b of cover component 14. In other embodiments engaging means 27 may comprise a U-shaped end portion of the first divider of the channel component configured to receive a single ridge extending from cover component 14. Other shapes and configurations of engaging means 27 are possible. In certain embodiments the “fit” between engaging means 27 may be a snap fit, a snug fit, a friction fit, or a loose fit.

In some embodiments, channel component 12 may have a generally Z-shaped cross-section as shown in bonding assembly 10f in FIG. 21. Bonding assembly 10f is similar to bonding assembly 10e. Unlike bonding assembly 10e, the first divider 18-1 of channel component 12 has a distal portion 18-1 a perpendicular to first divider 18-1. First divider 18-1 and distal portion 18-1a define second channel 13-2. Channel component 12 arid cover component 14 engage at engaging means 27.

In both bonding assemblies 10e and 10f, distal end of top portion 16 terminates with an end portion 19. End portion 19, second flange portion 18-2b and end portion 18-2c together define a flow path 21 (indicated by a dashed arrow in FIGS. 2E and 2I) for water, such as rain runoff. These components are configured to prevent water from entering channel 13-1. As best shown in FIG. 2F, these components direct water into a channel 122a in PV support frames 122 and thereby prevent water, such as rain runoff, from entering first channel 13-1. The diagonally upwardly and inwardly extending orientation of first flange portion 18-2a prevents water from infiltrating first channel 13-1.

In some embodiments, cover component 14 couples to channel component 12 to provide a gap 129, as shown in FIG. 2E for example. Electrical connectors 140 can be inserted through gap 129 into channel 13-1 to provide a conduit for electrical connectors. First flange portion 18-2a and end portion 19 may be biased against each other such that they abut each other in their normal state (to prevent water from infiltrating into channel 13-1) and a slight force is required to open, gap 129 to allow electrical connectors 140 through. Alternatively, gap 129 may normally exist between first flange portion 1B-2a and end portion 19, and a waterproof sealant or caulking (e.g. silicone, rubber, foam, neoprene, etc.) applied to close gap 129.

FIGS. 1C and 1D show a BIPV assembly 100 incorporating bonding assembly 10 according to an embodiment of the invention. System 100 includes bonding assembly 10, a rooftop assembly 110 and a PV assembly 120. In some embodiments, bonding assembly 10 is provided along the entire periphery (Le., rear, front and sides) of the rooftop assembly 110. Rooftop assembly 110 supports PV assembly 120.

Rooftop assembly 110 includes frame members 112, sheathing 114 and if required, wood strapping (e.g. battens) 116. In some embodiments, battens 116 may be excluded. In some embodiments, the components of rooftop assembly 110 are primarily made of wood, such as plywood and OSB panels. Other materials, such as concrete, plastic composites, aluminum and steel, can also be used to make the components of rooftop assembly 110.

In some embodiments, frame members 112 may be chords of a roof truss. In some embodiments, frame members 112 may be rafters or joists. In an example embodiment, frame member 112 may comprise 2″×4″ (50.8 mm×101.8 mm) top chords and 2″×6″ (50.8 mm×152.4 mm) bottom chords. Sheathing 114 may for example be plywood or oriented-strand board (OSB) sheets. Sheathing 114 is fixed to frame members 112 to provide shear strength. Truss blocks (not shown) can be used to stabilize the frame members 112 during installation when frame members 112 are, chords of a roof truss. To reinforce the structural integrity of rooftop assembly 120, strapping (not shown) can be used to provide lateral bracing to frame members 112.

Battens 116 are fixed to sheathing 114. In some embodiments, battens 116 are used to support PV assembly 120, for example for fixing brackets and clamps for PV support frames 122 and PV panels 124 of PV assembly 120. In an example embodiment, battens 116 can be 1″×4″ (25.4 mm×101.8 mm) and 12′ in length. In embodiments lacking battens 116, PV assembly 120 may be supported on sheathing 114.

In some embodiments, rooftop assembly 110 may be provided with a suitable waterproof membrane 135 to create a water, vapor and air barrier for rooftop assembly 110. In some embodiments, a waterproof membrane 135 may be applied to sheathing 114 before fixing battens 116 or PV assembly 120 to sheathing 114. In particular embodiments, membrane 135 may be a peel and stick underlayment such as TITANIUM™PSU 30 or similar material.

PV assembly 120 includes an array of a plurality of PV support frames 122 and a plurality of PV panels 124. PV support frames may be made of any suitable material such as polypropylene. PV support frames 122 may be fixed to battens 116, or to sheathing 114. In some embodiments, PV support frames 122 have one or more openings 126 for electrical connections between PV panels 124 to pass through.

PV panels 124 are mounted on PV support frames 122 by means known in the art such as clamps, brackets, screws and the like. PV panel 124 may for example be any commercially available panel, such as 1,685 mm×992 mm×35 mm Trina Honey Plus All-black 310 W PV modules. Each Trina Honey Plus All-black 310 W PV modules is made up of 6″×10″ (152.4 mm×254 mm) PV cells of monocrystalline/N-type silicon wafers. The Trina Honey Plus All-black 310 W PV modules have a minimum efficiency of 18.3%. The installed solar power capacity can vary. In some embodiments, the installed capacity is 10,850 Wₚ. In some embodiments, the installed capacity is 7,440 Wₚ.

The array of PV panels 124 of PV assembly 120 is arranged in a suitable size and shape to form a rooftop. In example embodiments directed to garage rooftops, PV panels 124 may be arranged in a 4×6 array or a 5×7 array.

FIGS. 2F to 2H show a BIPV assembly 180 incorporating bonding assembly 10e according to an embodiment of the invention. BIPV assembly 180 has features and functions similar to BIPV assembly 100.

Bonding assembly 10e integrates PV assembly 120 and rooftop assembly 110 as follows, as shown in FIGS. 2F to 2H. First channel 13-1 of bonding assembly 10e defines a protected conduit for electrical connectors 140 of PV panels 124 (that run between strings of PV panels 124 and/or between PV panels and other components such as combiner boxes and inverters, as described further herein).

Second region 13-2 accommodates components of rooftop assembly 110. Ridge 27b may be supported by batten 116. Lower segment 15b of side portion 15 begins immediately below ridge 27b and shields edges of components of rooftop assembly 110 such as batten 116, sheathing 114 and frame member 112, against weather elements such as wind and rain. In some embodiments, as shown in FIG. 26, lower segment 15b may also partially cover, a fascia or wall 150. Fascia or wall finishing, material 150 could, for example be a polycarbonate panel or other like building material. In other embodiments, fascial or wall 50 is absent.

Third region 13-3 receives PV assembly 120, namely a PV panel 124 mounted on a PV support frame 122. In some embodiments, the components of assembly 10e that define third region 13-3 are dimensioned to fittingly receive end portions of a PV panel 124 mounted on a PV support frame 122. In some embodiments, top portion 16 of cover component 14 may be flush with a top surface 125 of adjacent PV panel 124. In some embodiments, second flange portion 18-2b of channel component 12 extends partially through a gap between channel members 122a, 122b, 122c and 122d of frame 122 to provide a flow path for water to drain off portion 18-2b into drain channel 127 of frame 122. End portion 18-2c of channel component 12 may be supported by a structural member 122d of frame 122 as shown in FIG. 2F.

In some embodiments, a height of the channel segment H_{CS} of bonding assembly 10e (i.e., the portion from ridge 27b and above) is approximately the same as a thickness T_{PV} of PV assembly 120. In some embodiments, a ratio of height H_{CS} to a width of the channel segment W_{CS} ranges from 0.8 to 1.2. In some embodiments, a height of lower segment H_{LS} of bonding assembly 10e is at least as great as height H_{CS}.

In operation, rooftop assembly 110 may be provided, and then PV assembly 120 mounted thereon. Bonding assembly 10e may then be installed, running electrical connectors 140 from PV assembly 120 into first channel 13-1 as required, and then sealing gap 129. Fastening means may be used to secure bonding assembly 10e to a corresponding part of a PV assembly 120 and/or rooftop assembly 110. Example fastening means include clamps, brackets, and screws.

Referring to FIG. 3, PV assembly 120 has electrical connectors 140, such as electrical wires, connecting PV panels 124. In some embodiments, electrical connectors 140 for PV panels 124 are pre-cut to pre-determined lengths and pre-fitted with twist-lock connectors. In some embodiments, the pre-determined lengths of electrical connectors correspond to the lengths needed to connect PV panels to their corresponding string disconnects, DC disconnect, and into a DC combiner box 141. The pre-determined lengths of electrical connectors provided would be in addition to the electrical connectors already provided with each PV panel for connecting immediately adjacent PV panels. In some embodiments, multiple PV panels are strung together. In the illustrated embodiment, two strings 145, 147 are provided by each stringing 12 PV panels together. Another string 149 is provided by stringing 11 PV panels. The pre-determined lengths of electrical connectors 140a, 140b, 140c correspond to lengths needed to connect each of the three strings 145, 147, 149 to their corresponding string disconnects, DC disconnect, and into a DC combiner box 141, as well as to connect PV panels at, the end of a row or column of the PV assembly. In an example embodiment, the length of electrical connectors 140 can be 39′-4 ⅜″ (12,000 mm), 19′-8 ¼″ (6,000 mm), or 9′-10 ⅛ ″(3,000 mm). Electrical connectors 140 connect PV panels 124 and provide an electrical circuit. The direct current (DC) electricity generated by PV panels 124 is consolidated by a DC combiner box 141 with three strings of PV panels 145, 147, 149 as one source into a current inverter 142. Electrical connectors 140 from strings of PV panels 124 are connected in parallel to an interface or current converter, such as an inverter 142, for converting DC electricity generated by PV panels 124 into alternating current (AC) electricity at a certain voltage, such 110/120V, which can then be utilized by household alternating current devices and appliances. One example inverter is Solar Edge (Schneider Electric, Inge-Team) that is rated up to 240 volts DC input and 11.4 kW maximum capacity.

PV assembly 120 can be operatively coupled to a commercially available solar PV power and energy storage system. In some embodiments, the solar PV power and energy storage system includes long-life lithium ion batteries. The solar PV power and energy storage system works in conjunction with PV assembly 120 for storing and delivering PV-converted power to the home and other electric loads such as electric vehicles.

The AC electricity is stored in a battery system 146. In some embodiments, the battery system includes a 16 kWh (81″×25″×9″; 2,057.4 mm×635 mm×228.6 mm) or 12 kWh (62″×25″×9″; 1,574,8 mm×635 mm×228.6 mm) lithium ion battery bank, such as the Sonnen Batterie Eco Compact. The battery bank may be equipped with an enclosure, an automatic temperature control and monitoring system, energy tracking and system monitoring software, and/or fault-detection capabilities, including a display module for the home and/or a mobile application for remote system monitoring by the home owner.

In some embodiments, AC electricity is supplied to the battery system as a priority, and then is supplied to the utility grid to supplement any shortfalls. In some embodiments, the AC electricity is supplied during a utility failure and the battery system is only charged from solar energy.

In some embodiments, BIPV rooftop assembly 100 is installed to enable home owners to adopt solar-PV generation regardless of the regulatory environment or specific electric utility requirements. When long-life lithium ion batteries are coupled with a building integrated PV rooftop assembly, the batteries serve as a “behind-the-meter” AC-coupled energy storage system for storing and delivering PV generated power to the home and other electric loads such as electric vehicles. This PV and energy system topology, commonly known as “self-consumption”, enables a home to generate its own solar power for its own use while retaining the cost effectiveness and reliability of grid power to recharge the batteries when there is not enough solar energy available. In some embodiments, BIPV rooftop assembly 100 may provide enough power to the home and to drive an electric vehicle an average of 50 km per day. In jurisdictions where the regulatory environment and the local utility companies permit “net metering” by accepting PV-generated power, a home can also benefit from the sale of excess power generated by a BIPV rooftop assembly to the electric grid.

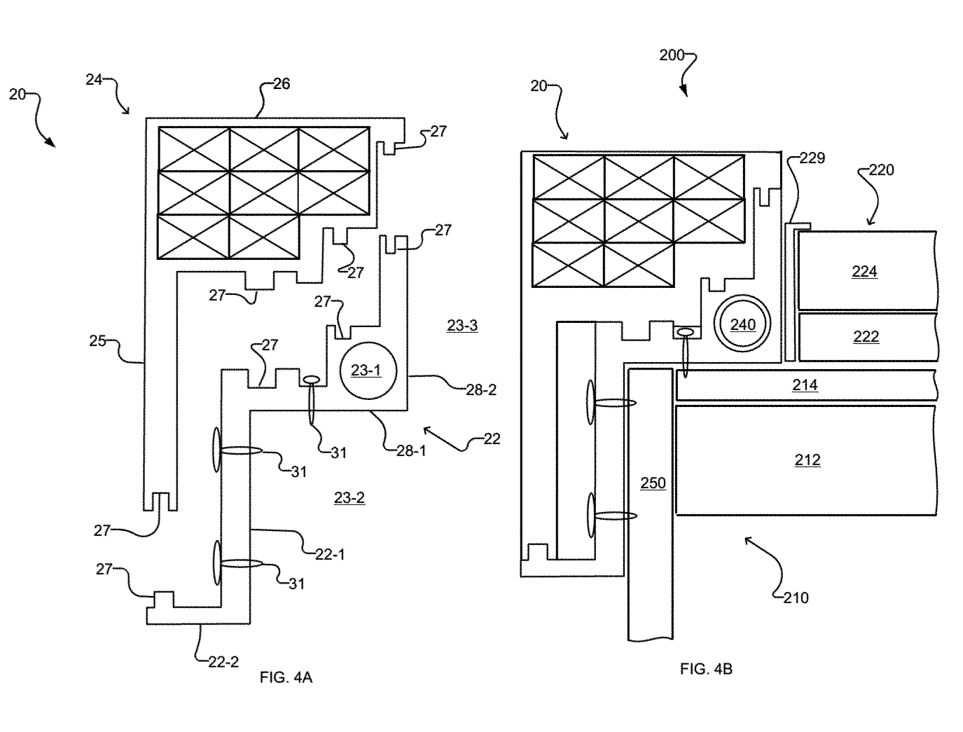

FIGS. 4A and 4B show a bonding assembly 20, and a BIPV assembly 200 incorporating bonding assembly 20, according to another embodiment of the invention. Bonding assembly 20 has a channel component 22 and a cover component 24. In some embodiments, channel component 22 and cover component 24 are manufactured separately and then are coupled together by one or more fasteners 27. Fasteners 27 may be any suitable means known in the art such as a maleffemale clipping mechanism, screws, and the like. In other embodiments, the channel component and the cover component are manufactured together as one integral piece as in bonding assembly 20a shown in FIG. 3C. In some embodiments, channel component 22 and cover component 24 are coupled together with fasteners and gaskets to create a waterproof seal between the two components.

Channel component 22 has an elongated body and it may extend along the periphery of a building structure, or along one side of a periphery of a building structure, or along a portion of one side of a periphery of a building structure.

Channel component 22 at least partially defines a first channel 23-1, a second channel 23-2, and a third channel 23-3. In some embodiments, first channel 23-1 is adjacent to second channel 23-2, the two channels are separated by a first divider 28-1 of channel component 22. In some embodiments, first channel 23-1 is also adjacent to third channel 23-3, the two channels are separated by a second divider 28-2 of channel component 22. First divider 28-1 is oriented perpendicular to second divider 28-2.

Channel component 22 has a generally step-shaped cross-section, consisting of first divider 18-1, from which perpendicularly extends a second divider 18-2, from which perpendicularly extends a linear portion 22-1, from which perpendicularly extends a linear portion 22-2. Cover component 24 has a generally an L-shaped cross-section and couples to channel component 22. Cover component 24 has an elongated body and may extend to a length corresponding to that of channel component 22. Cover component 24 comprises a top portion 26 and a perpendicularly extending side portion 25. In some embodiments, cover component 24 fastens to channel component 22 with a plurality of fasteners 27. Cover component 24 comprises a honeycombed web 29 of plastic or other cost-effective lightweight material to add strength and durability to bonding assembly 20.

Bonding assembly 20 integrates PV assembly 220 and rooftop assembly 210 as follows. First channel 23-1 is defined by a bore in channel component 22 that serves as a conduit for electrical connectors 240 of PV panel 224.

First divider 28-1 and linear portion 22-1 together form an L-shaped portion defining second channel 23-2 that receives end portions of one or more building structural members of rooftop assembly 210, such as a fascia and/or a wall 250, frame member 212 and/or sheathing 214. Such building structural members may be secured to the L-shaped portion by a plurality of fasteners 31.

Second divider 28-2 provides a planar surface defining third channel 13-3. In some embodiments, the planar surface of second divider 28-2 receives a PV assembly 220, for example a PV panel 224 mounted on a PV support frame 222, via a PV clamp 229 or other suitable securing means known in the art. PV support frame 222 may be supported from below by sheathing 214 and frame member 212 secured in second channel 23-2.

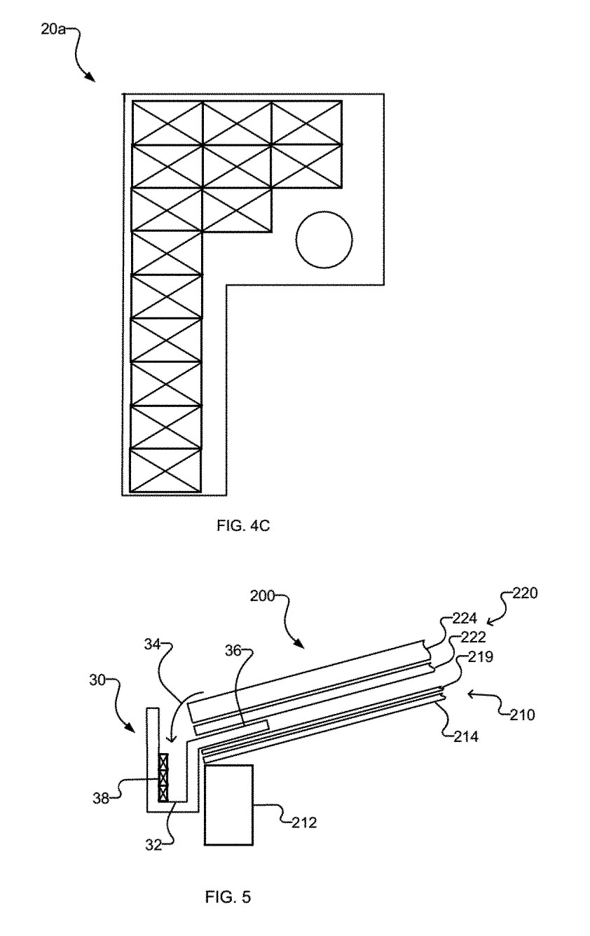

In some embodiments, BIPV 200 may be provided with bonding assembly 20 along the rear and sides of rooftop assembly 210, and with a flashing component 30 such as that shown in FIG. 5 provided along the front of rooftop assembly 210. Flashing component 30 has a gutter 32 into which rain water from the surface of PV panel 224 drains as indicated by arrow 34. Flashing component 30 engages an edge of a building structure such as rooftop assembly 210. In some embodiments, a flanged portion 36 of flashing component 30 is received between PV assembly 220 and roofing assembly 210, in particular between waterproofing membrane 219 applied to sheathing 214, and PV support frame 222. Flashing component 30 can be made of any suitable building material such as plastic or aluminum or steel sheet metal. Portions of flashing component 30 may be made of a honeycombed web 38 of plastic or other cost-effective lightweight material to add strength and durability.

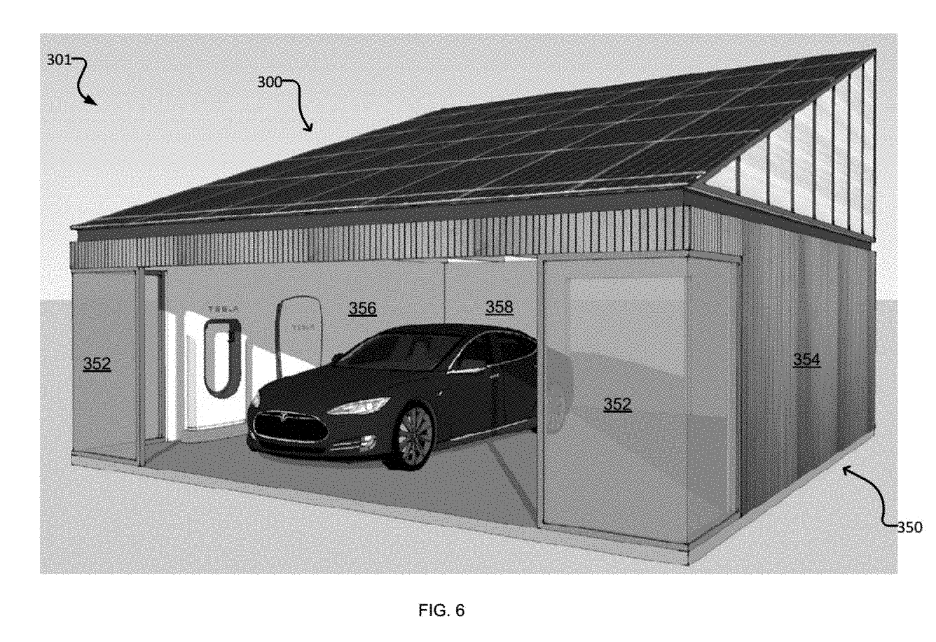

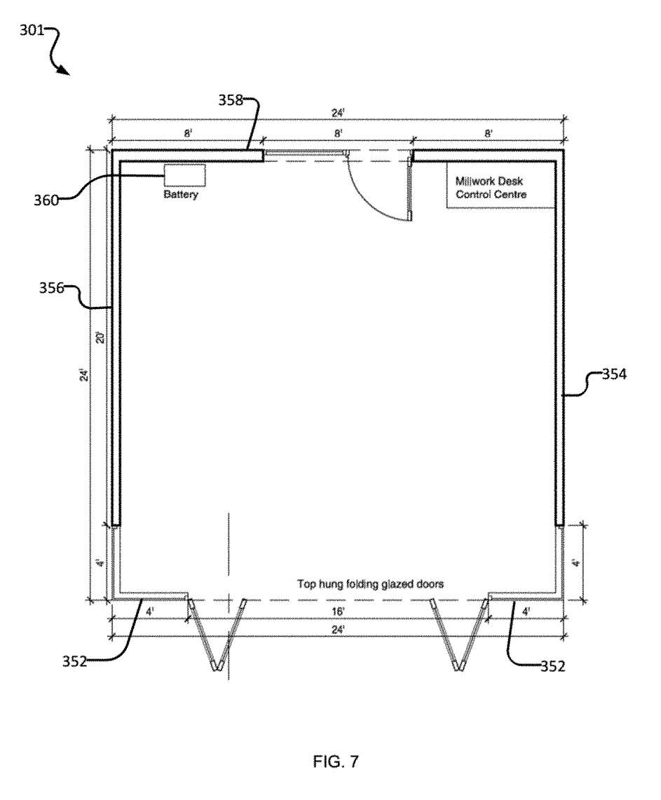

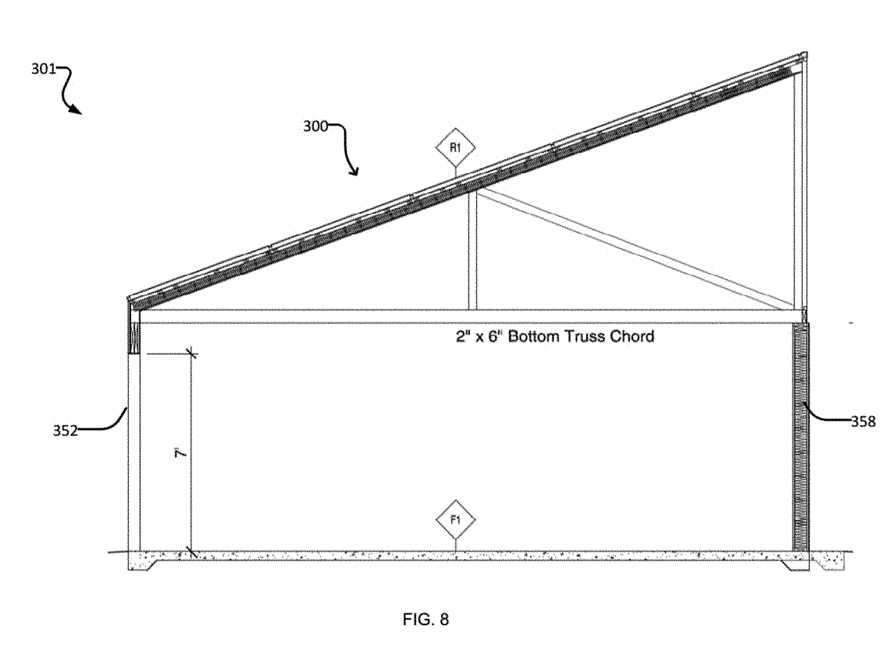

FIGS. 6-8 show a residential garage 301 according to an embodiment of the invention. Garage 301 integrates a garage assembly 350 with a BIPV assembly 300. BIPV assembly 300 may for example be similar to BIPV assembly 100 or BIPV assembly 200. BIPV assembly 300 includes a bonding assembly 310, a PV assembly 320 and a rooftop assembly 312. BIPV assembly 300 provides a complete roof structure for garage 301. In example embodiments, garage 301 may be provided in two sizes: 24′×24′ (7,315 mm×7,315 mm) and 20′×20′ 6,098 mm×6,098 mm). In both cases, the maximum height of the complete structure will be 15′ (4,572 mm). In other embodiments, garage 301 may be provided in different sizes. Garage 301 may have a mono-pitched roof (i.e., a roof with one slope), as in the illustrated embodiment, or a flat roof.

Garage assembly 350 includes four walls: a front wall 352, a first side wall 354, a second side wall 356, and a back wall 358. Walls 352, 354, 356, 358 are made primarily from lumber, e.g. pre-engineered, building-code-approved stick-frame lumber, and/or pre-fabricated panels such as structural insulated panels (SIP). In other embodiments, walls 352, 354, 356, 358 may be made from any suitable materials and combinations of materials.

In an example embodiment, garage assembly 350 is constructed using materials including the following:
side walls 354, 356 built with 2″×4″ (58.8 mm×101.8 mm) studs, 16″ (406.4 mm) on centre and ½″ (12.7 mm) plywood sheathing to provide shear strength;
front wall 352 built with 2″×4″ (50.8 mm×101.8 mm) studs, 16″ (406.4 mm) on centre and ½″ (12.7 mm) plywood sheathing to provide shear strength;
back wall 358 built with 2″×6″ (50.8 mm×152.4 mm) SPF No. 2 studs, 16″ (406.4 mm) on centre sheathed with ½″ (12.7 mm) plywood sheets;
back wall 358 including a 2-ply 2″×10″ (50.8 mm×254 mm) header beam and incorporates a standard size access door as well as a standard 8′×6′-8″ (2,438 mm×2,032 mm) window;
front wall 352 including a 5 ¼×11 ⅞″ (133.3 mm×301.6 mm) Parallam™ header beam supported by 4 4-ply 2″×6″ (50.8 mm×152.4 mm) posts and incorporates a 16′ (4,877 mm) standard garage door together with a standard garage door opener;
a wall section that will support battery enclosure 260 containing the battery bank of the BIPV assembly will be double studded and double sheathed, insulated and will be finished with gypsum board with taped and jointed seams;
walls 352, 354, 356, 358 filled with batt insulation and left unfinished; vapour barrier paper will be installed on the wall sheathing and finished with a water-resistant pre-cut cladding system;
10 W ceiling-mounted LED lights with light switch;
duplex power receptacles (grounded);
¾″ (19 mm) galvanized steel conduit with the necessary couplings and support brackets;
gauge 10 electrical wire; and
15A breakers.

In an example embodiment, rooftop assembly 310 of BIPV assembly 300 is constructed using materials including the following:
standard lumber roofing trusses to support the rooftop assembly, fabricated with 2″×4″ (50.8 mm×101.8 mm) framing and 2″×6″ (50.8 mm×152.4 mm) bottom cords;
⅜″ (9.52 mm) oriented-strand board (OSB) sheets fastened to the trusses with construction staples to provide shear strength;
truss blocks used to stabilize the trusses during installation;
water proofing membrane attached to the OSB sheets;
12′ (3,658 mm) 2″×4″ (50.8 mm×101.8 mm) wood battens to support the polypropylene PV support frames and PV modules, and to fix the PV module brackets and clamps;
steel staples 1 ½″×½″ (38.1 mm×12.7 mm) to fix the OSB sheets to the roof trusses;
3 ¼″ (82.5 mm) steel roofing nails to block trusses together and to fix them to the garage walls; and
12′ (3,658 mm) 1″×4″ (50.8 mm×101.8 mm) wood strapping to provide lateral bracing to the wood trusses.

In an example embodiment, PV assembly 320 of BIPV assembly 300 is constructed using, materials including the following:
IRFTS Easy Roof 1,685 mm×1001 mm×3 mm polypropylene PV support frames together with aluminium brackets and clamps and stainless steel screws;
1,650 mm×992 mm×35 mm PV modules Trina Honey Plus All-black 310 W;
pre-cut and pre-fitted electrical wires (with twist locks) for connecting the PV modules, e.g. 39′-4 ⅜″ (12,000 mm), 19′-8 ¼″ (6,000 mm), and 9′-10 ⅛″ (3,000 mm);
DC combiner box;
lightning arrestor on the DC side;
98′-5 ⅛″ (30,000 mm) Romex cable run from DC to inverter;
300 A DC disconnect switch;
10 kW PV AC inverter (Schneider Electric, Solar Edge, Inge-Team);
AC breaker disconnect box;
kilowatt-hour meter (kWh);
8′ (2,438 mm)copper ground rod;
1/0 cable for ground loop; and
battery system including 16 kWh or 12 kWh lithium ion battery bank (Sonnen Batterie Eco Compact for example). It has either 4×4 kWh modules or 3×4 kWh modules guaranteed for 10,000 full discharge/recharge cycles. The dimensions of the 16 kWh bank are 81″×25″×9″ (2,057.4 mm×635 mm×228.6 mm). The dimensions of the 12 kWh bank are 62″×25″×9″ (1,574.8 mm×635 mm×228.6 mm). The battery system also includes an 80 A AC breaker disconnect box. The system includes energy tracking and system monitoring software as well as fault-detection capabilities inclusive of a display module for the home and a mobile application for remote system monitoring by the home owner. The battery system is insulated in an enclosure with automatic temperature control and monitoring. The enclosure is fabricated with pre-engineered, insulated panels. The dimensions of the enclosure for the 16 lWh bank are 66″×29″×13″ (1,676.4 mm×736.6 mm×330.20 mm). The dimensions of the enclosure for the 12 kWh bank are 85″×29″×13″ (2,159 mm×736.6 mm×330.20 mm).

Some embodiments of the invention provide a method of constructing a residential garage. The method comprises constructing a residential garage using techniques known to those skilled in the art to assemble the components of residential garage 301, or known equivalents thereof, as described herein. In some embodiments, preliminary steps of the method comprise: determining a pitch and/or orientation of the roof to optimize capture of solar radiation based on a site where garage 301 is to be located; and constructing a concrete pad and apron on the site.

Some embodiments of the invention provide a residential garage kit incorporating the BIPV assemblies described herein. The kit comprises the components of residential garage 301, or known equivalents thereof, as described herein, wherein the components are sized cut to fit, and palletized for ease of storage, transportation and installation. In some embodiments, the kit may be installed by general tradespersons and may be certified by the Underwriters Laboratories Canada (ULC) or Canadian Standards Association (CSA), or other equivalent standards organizations to reduce the need for specialized contractors and complex design and permitting. The kit also comprises an installation manual with instructions setting out the method of constructing a residential garage as described herein.

When processes or blocks are presented in a given order, alternative examples may perform routines having steps, or employ systems having blocks, in a different order, and some processes or blocks may be deleted, moved, added, subdivided, combined, and/or modified to provide alternative or sub-combinations. Each of these processes or blocks may be implemented in a variety of different ways. Also, while processes or blocks are at times shown as being performed in series, these processes or blocks may instead be performed, in parallel, or may be performed at different times.

Where a component is referred to above, unless otherwise indicated, reference to that component (including a reference to a “means”) should be interpreted as including as equivalent of that component any component which performs the function of the described component (i.e., that is, functionally equivalent), including components which are not, structurally equivalent to the disclosed structure which performs the function in the illustrated exemplary embodiments of the invention.

Specific examples of systems, methods and apparatus have been described herein for purposes, of illustration. These are only examples. The technology provided herein can be applied to systems other than the example systems described above. Many alterations, modifications, additions, omissions, and permutations are possible within the practice of this invention. This invention includes variations on described embodiments that would be apparent to the skilled, addressee, including variations obtained by: replacing features, elements and/or acts with equivalent features, elements and/or acts; mixing and matching of features, elements and/or acts from different embodiments; combining features, elements and/or acts from embodiments as described herein with features, elements and/or acts of other technology; and/or omitting or combining features, elements and/or acts from described embodiments.

1. A bonding assembly for joining a rooftop assembly and a photovoltaic (PV) assembly, the bonding assembly comprising:
an elongate channel component
an elongate cover component engageable with the channel component to form a generally P-shape cross section;
wherein the channel component comprises a first divider perpendicular and integrally formed with a second divider,
wherein the cover component comprises a side portion perpendicular and integrally formed with a top portion, wherein the top portion is perpendicular and integrally formed with an inner portion;
wherein an upper segment of the side portion, the top portion, the inner portion, the first divider and the second divider define a first channel;
wherein the second divider comprises a first flange portion extending diagonally upwardly and inwardly into the first channel;
wherein a gap is provided between an end portion of the inner portion and the first flange portion;
wherein the second divider comprises a second flange portion extending horizontally and inwardly in direction opposite to the first channel.

2. A bonding assembly according to claim 1, wherein the second flange culminates in an end portion extending diagonally and inwardly.

3. A bonding assembly according to claim 2, wherein the channel component and cover component comprise corresponding engaging means.

4. A bonding assembly according to claim 3, wherein the engaging means is provided at an end of the first divider of the channel component and a mid-region of the side portion of the cover component.

5. A bonding assembly according to claim 4, wherein the engaging means comprise spaced apart ridges on the cover component configured to fittingly receive the end of the first divider of the channel component.

6. A bonding assembly according to claim 5, wherein the first divider of the channel component and a lower segment of the side portion of the cover component define a second region. A bonding assembly according to claim 6, wherein the second divider of the channel component and the inner portion of the cover component define a third region.

8. A bonding assembly according to claim 7, wherein a ratio of a height of a channel segment and the width of the channel segment ranges from 0.8 to 1.2.

9. A building integrated photovoltaic (BIPV) system comprising:
a bonding assembly according to claim 8;
cut-to-size electrical connectors (with twist locks) of a photovoltaic (PV) panel of a PV assembly received in the first channel of the bonding assembly;
a roofing assembly received in the second region channel of the bonding assembly; and
the PV assembly received in the third region of the bonding assembly.

10. A BIPV assembly according to claim 9 wherein the PV assembly comprises the PV panel and a PV support frame.

11. A BIPV assembly according to claim 10 wherein the PV support frame comprises a drain channel, and wherein the end portion of the second flange extends diagonally and inwardly toward the drain channel.

12. A BIPV assembly according to claim 11 wherein the height of the channel segment is approximately the same as a thickness of the PV assembly.

13. A BIPV assembly according to claim 12 wherein the top portion of the cover component is approximately flush with a top surface of the PV panel.

14. A BIPV assembly according to claim 13 wherein the roofing assembly comprises a batten, a sheathing member, and a framing member.

15. A BIPV assembly according to claim 14 wherein the sheathing member is lined with a waterproof membrane.

16. A BIPV assembly according to claim 15 wherein outer edges of the batten, the sheathing member, the framing member and the waterproof membrane abut a lower segment of the side portion of the cover component.

17. A residential garage comprising:
a BIPV assembly according to claim 16; and
a garage assembly.

18. A residential garage according to claim 17, wherein the o is a mono-pitched roof or a flat roof.

19. A method of making a residential garage comprising:
(a) determining a pitch and/or orientation of a roof of the garage to optimize capture of solar radiation based on a site where the garage is to be located;
(b) constructing a pad and an apron on the site;
(c) tructing a residential garage according to claim 18 on the site.

20. A kit for a residential garage comprising:
components of a residential garage according to claim 18, wherein the c nents are sized, cut to fit, and palletized; and
an installation manual with instructions setting out a method of making a residential garage according to claim 19.
